(19) United States
(12) Patent Application Publication
(10) Pub. No.: US 2019/0283569 A1
(43) Pub. Date: Sep. 19, 2019

(54) Device For Sequentially Opening And Closing Air Flaps

(71) Applicant: Compagnie Plastic Omnium, Lyon (FR)

(72) Inventors: Stéphane Parra, Vaulx-En-Velin (FR); Philippe Gilotte, Benonces (FR)

(73) Assignee: Compagnie Plastic Omnium, Lyon (FR)

(21) Appl. No.: 16/065,557

(22) PCT Filed: Dec. 20, 2016
(86) PCT No.: PCT/FR2016/053560

§ 371 Date: Jun. 22, 2018

(30) Foreign Application Priority Data
Dec. 22, 2015 (FR) 1563019

(51) Int. Cl. B60K 11/08; F16H 27/06

(52) U.S. Cl. CPC B60K 11/085; F16H 27/06

(57) ABSTRACT

Device for manoeuvring a plurality of flaps, having mechanical way including a drive wheel, supporting, in a raised position, a circular locking disc with a diameter smaller than and the same axis of rotation as the drive wheel, and also including a plurality of rockers, and connected by mechanical transmission way to one or more flaps, the rockers including at least two semicircular cutouts having a radius equal to the radius of the locking disc and which are arranged such that, when a rocker is placed in one position, the centre of a semicircular cutout is disposed on the main axis such that the locking disc engages with the semicircular cutout and locks the rocker in the position.

### BACKGROUND OF THE INVENTION

The invention concerns a mechanical device for deploying and for closing a set of flaps used in motor vehicles, to modify the conditions of entry of air into an engine compartment and to encourage thermal exchanges.

When the engine is disposed at the front of the vehicle, a guide nozzle equipped with one or more flaps is commonly disposed behind the grille, or behind any other air intake situated on the vehicle. On pivoting simultaneously about their respective axes, the flaps allow blocking of all or of some of the air entering in the direction of the front face of the radiator or to allow same to pass. It is equally possible, by altering the angle of inclination of the flaps, to regulate the quantity of air serving to cool the engine.

These air intake devices are preferably equipped with a plurality of flaps having a small surface area, with the aim of distributing over a greater number of flaps the aerodynamic forces exerted on the surface of the flaps when the vehicle is traveling at high speed, and reducing the free space necessary to allow their relative angular movement.

The flaps may be disposed at will between the radiator and the bars of the grid forming the grille or contribute to the general styling of the body and be visible from the exterior of the vehicle.

In the closed position of the flaps, the flow of ambient air arriving at the radiator is very small in order to allow the thermal regime of the engine to increase and to stabilize at the optimum operating temperature. When the temperature of the engine exceeds a given threshold, a mechanism disposed behind the grille allows control of the angle of opening of the flaps as a function of engine parameters and regulation of the incoming volume of air.

### Description of the Prior Art

Thus, the publication FR 2 866 604 describes a device for regulation of blocking means that are continuously adjustable as a function of the power demanded by the motor vehicle.

The publication FR 2 967 945 describes an air flow regulation device, comprising flaps adapted to be deformed and to be turned about a rotation axis by actuating means such as electroactive polymer fibers or hydropneumatic cylinders or more simply electric motors assigned to the rotation of each of the flaps.

The publication WO 2007/130847 describes a device similar to the preceding device in which the flaps are controlled by the movement produced by the change of state of a shape memory type material, an electroactive polymer, a piezoelectric material or a magnetorestrictive material. The change of state of the active material is controlled by an electrical control device.

The publication FR 2 825 326 describes an engine ventilation device in which the flaps are controlled by an electromagnetic actuator acting on a link controlling the simultaneous rotation of a set of flaps.

All these devices allow continuous regulation and adjustment of the volume of air admitted at the inlet of the cooling system of the vehicle. However, they have the disadvantage that the actuator has to be maintained at a given electrical voltage to hold the flaps in the desired position. This electrical voltage increases as the aerodynamic force applied to the flaps increases when the vehicle is traveling at high speed. This results in a high and undesirable consumption of energy.

### SUMMARY OF THE INVENTION

An object of the invention is to limit the disadvantage referred to above.

There is therefore proposed a device for maneuvering a plurality of flaps, each pivoting about an axis, and intended to be placed in front of cooling means of a motor vehicle. This maneuvering device is characterized in that it comprises mechanical means including a drive wheel, driven in rotation about a main axis, one of the faces of the disc formed by the drive wheel supporting in a raised position a circular locking disc with a diameter smaller than and the same rotation axis as the drive wheel. The maneuvering device further includes a plurality of rockers each freely articulated about a secondary axis parallel to the main axis and connected by mechanical transmission means to one or more flaps, said rockers comprising at least two semicircular cutouts having a radius equal to the radius of the locking disc and which are arranged so that, when a rocker is placed in one position, the center of a semicircular cutout is placed on the main axis, so that the locking disc engages with said semicircular cutout and locks said rocker in said position.

When the rotation of the drive wheel stops in any position each of the rockers is retained by the locking disk in the position that it occupied at that moment of the cycle and without it being required to maintain under voltage the motor driving the drive wheel in rotation (see below).

By indexing the maneuvering device at given positions as a function of predetermined engine parameters, for example the engine temperature, it becomes possible to allow to enter only the flow of air necessary for cooling the engine. Opening or closing an additional flap allows this flow to be increased or decreased and the flow of air to be regulated by successive steps.

The maneuvering device according to the invention may also comprise the following features, separately or in combination:
The semicircular cutouts are placed on a peripheral edge of the rocker.
The drive wheel supports an axial shaft disposed on the same face of the disk formed by the drive wheel supporting the locking disk, at a distance from the main axis greater than the radius of the locking disk.
Each rocker comprises radial slots disposed between two adjacent semicircular cutouts, in which said shaft circulates to cause a rocker to pivot from one position to another position adjacent the preceding position about its secondary axis.
The locking disk includes a recess disposed radially in line with the shaft, so as to allow the pivoting of a rocker when the latter changes position.
The mechanical transmission means connecting a rocker to one or more flaps are formed by:
   a set of links connecting the body of the rocker to the rotation shaft or to a rear face of the flap or flaps,
   a flexible cable transmission of push/pull type,
   a system of gears.
Each rocker successively occupies a number of fixed positions equal to the number of semicircular recesses that it supports, so that it is possible to dispose the flaps successively in a plurality of particular fixed positions to adjust the quantity of air reaching the cooling means.
When the drive wheel effects a rotation of one turn, each of the rockers effects, in accordance with the sequence imposed by the direction of rotation of the drive wheel a movement of rotation from one position to another position adjacent to the preceding position.
Each rocker successively occupies each of the possible positions when the drive wheel has effected as many turns on itself as the number of radial slots supported by a rocker.
When a rocker is placed in a position, the torque applied to the main rotation shaft, and resulting from the aerodynamic forces exerted on the flap or flaps connected to said rocker when the vehicle is in motion, is substantially zero.
The drive wheel is rotated by a motor coupled to a gearbox.
The rotation of the drive wheel may be interrupted between the change of position of two rockers circumferentially placed in adjacent positions, so that some of the flaps are in a position different from the position of others.

### BRIEF DESCRIPTION OF THE DRAWINGS

The invention will be better understood on reading the appended figures, which are provided by way of nonlimiting example, and in which:

FIG. 1 is a perspective view of a maneuvering device according to the invention.

FIG. 2 shows, seen from above, the mechanical means of the maneuvering device illustrated in FIG. 1.

FIGS. 2a and 2b show alternative embodiments of the rocker forming part of the mechanical means.

FIG. 3 is a perspective view of the maneuvering device, in which a flap has passed from the closed position to the open position.

FIGS. 3a, 3b, 3c show the main phases of the movement of the mechanical means to cause the maneuvering device to pass from the state shown in FIG. 1 to the state shown in FIG. 3.

FIG. 4 is a perspective view of the maneuvering device in which all the flaps are in the open position.

FIGS. 4a, 4b, 4c show the main phases of the movement of the mechanical means to cause the maneuvering device to pass from the state shown in FIG. 3 to the state shown in FIG. 4.

FIG. 5 shows as seen from above an alternative embodiment of the mechanical means.

FIGS. 5a, 5b, 5c, 5d, 5e, 5f, 5g, 5h, 5i and 5j show the main phases of the movement of the mechanical means represented in FIG. 5.

### DETAILED DESCRIPTION OF THE INVENTION

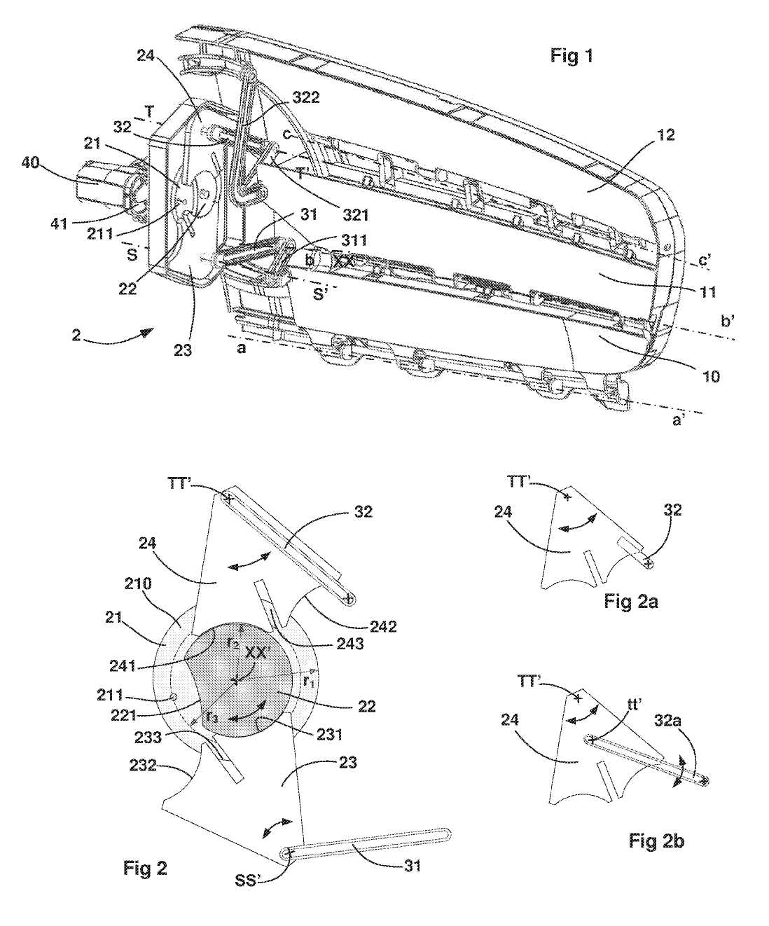

The maneuvering device shown in FIG. 1 comprises three flaps 10, 11, 12, the opening or closing of which controls the entry of a flow of air intended to cool an engine (not represented) of a motor vehicle, when the vehicle is in motion.

The flaps 10, 11 and 12 are articulated about respective axes aa′, bb′ and cc′. These axes are not necessarily parallel to one another.

The mechanical means 2 comprise a drive wheel driven in rotation about a main axis XX′ by a motor 40 coupled to a gearbox 41.

Rockers, here two in number, respectively 23 and 24, are each articulated to rotate freely about a secondary rotation axis, respectively SS′ and TT′. The secondary rotation axes SS′ and TT′ are parallel to the main rotation axis XX′.

The rotation of the rockers about their respective secondary rotation axes controls the movement of the flaps.

Accordingly, the rocker 23 is connected to the flap 10 by a link 31 fixed to the rocker 23 in the embodiment on which the present description is based. The link 31 and the rocker 23 could therefore form a single component pivoting about the axis SS′.

The link 31 is connected to the flap 10 by a second link 311.

The rocker 24 supports a link 32, also fixed to the rocker 24. The link 32 and the rocker 24 could therefore also form a single component pivoting about the secondary rotation axis TT′.

The link 32 is connected to a link 321 articulated on the flap 11. The flap 12 is connected to the flap 11 by a link 322. The movement in rotation of the rocker 24 allows the flaps 11 and 12 to be moved simultaneously.

It will be noted here that the rotation of the flaps about their axes by the rockers may be produced by any other mechanical transmission means such as, for example, sets of gears, or by flexible cables of push/pull type.

FIG. 2 is a more detailed representation of the members forming the mechanical means of the maneuvering device.

The drive wheel 21 supports on one of its faces 210 a locking disk 22. This locking disk has a radius r₂ less than the radius r₁ of the drive wheel 21.

Each rocker includes at its periphery a plurality of semicircular cutouts of concave shape, here two semicircular cutouts per rocker. The number of semicircular cutouts is generally exactly the same on each of the rockers. The rocker 23 comprises two semicircular cutouts 231 and 232, and the rocker 24 comprises two semicircular cutouts 241 and 242. These semicircular cutouts have a radius r₂, identical to the radius of the locking disk 22.

The secondary rotation axes SS′ and TT′ are disposed so that when a rocker is in a given angular position the center of a semicircular cutout is disposed on the main axis XX′. As a result of this the ring of the locking disk engages the semicircular cutout of the rocker which comes to bear on the locking disk. The rocker is prevented from rotating by the locking disk 22, and remains retained in this position during the rotation of the drive wheel and of the locking disk. Each rocker is therefore able to occupy as many positions as there are semicircular cutouts that it supports, which, in the example shown in FIG. 2, is limited to two positions, corresponding to the closed position and to the open position of the flaps.

FIG. 2 shows the situation in which the semicircular cutout 231 of the rocker 23 and the semicircular cutout 341 of the rocker 24 are engaged by the locking disk 22. The rockers 23 and 24 are then retained in their respective positions by the locking disk 22.

It will be noted that the forces exerted by the flow of air on the flaps 10, 11 and 12 and transmitted by the links to the rockers in the form of a torque then produce a resultant torque equal to zero about the axis XX′, and that it is no longer necessary to exert a particular motor torque to retain the rockers in position.

The drive wheel 21 also supports an axial shaft 211 extending axially from the face 210 supporting the locking disk 22. The axial shaft 211 is disposed at a distance r₃ from the axis XX′ greater than the radius r₂ of the locking disk 22.

Each rocker includes one or more radial slots, respectively 233, 243 each disposed between two adjacent semicircular cutouts. The radial slot 233 of the rocker 23 is disposed between the semicircular cutouts 231 and 232, and the radial slot 243 of the rocker 24 is disposed between the semicircular cutouts 241 and 242.

The rotation of a rocker about its axis is effected by causing the drive wheel to rotate. The axial shaft 211 then engages in the radial slot of the rocker and drives the latter in rotation about its secondary rotation axis.

A recess 221 is formed in the locking disk in line with the axial shaft to allow the rotation and the change of position of the rocker. As the rotation of the drive wheel continues, the axial shaft 211 leaves the radial slot, and the locking disk engages the next semicircular cutout corresponding to the next position in which the rocker is immobilized during further rotation of the drive wheel.

FIG. 2a shows the situation in which, when a link, such as the link 32, is prevented from rotating relative to the rocker, it may form with the latter a single component. In this case the rotation axis of the link coincides with the secondary rotation axis about which the rocker is articulated.

FIG. 2b shows the situation in which the link 32a is articulated on the rocker 24 by a ball joint with axis tt′.

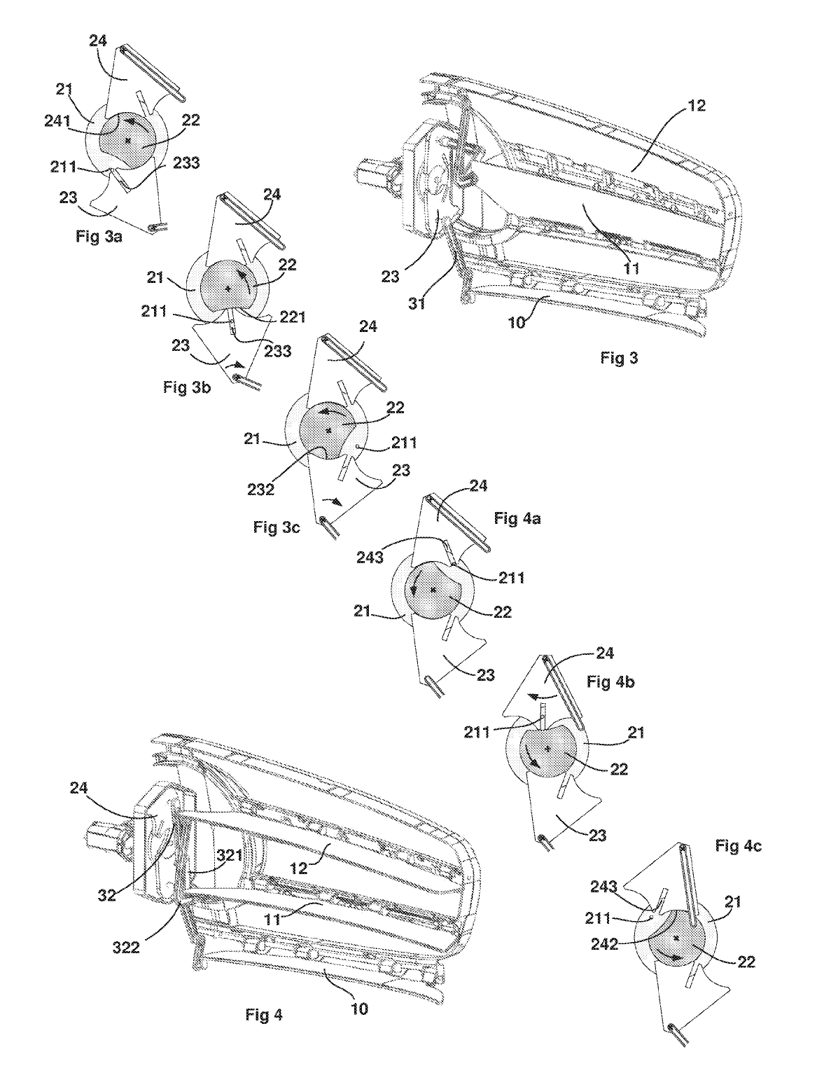

FIG. 3 shows the case in which the flap 10 has passed form the closed position as represented in FIG. 1 to the open position. The flaps 11 and 12 are in the closed position.

The steps shown in FIGS. 3a, 3b and 3c change the position of the rocker 23.

When the drive wheel is caused to rotate, the shaft 211 penetrates into the radial slot 233 as represented in FIG. 3a. The locking disk is engaged in the semicircular cutout 241 and holds the rocker 24 in position.

The rocker 23 is driven in rotation by the shaft 211, as represented in FIG. 3b. The recess 221 frees up the space allowing the rotation of the rocker 23 about its secondary rotation axis.

On further rotation of the drive wheel 21 (FIG. 3c), the axial shaft 211 leaves the radial slot 233 and the locking disk 22 engages the semicircular cutout 232, thus depriving the rocker 23 of the possibility of being moved about its secondary rotation axis.

The movement of the rocker 23 drives the rotation of the link 31 acting on the flap 10, which passes from the closed position to the open position.

When it is wished to increase the volume of external air penetrating into the engine compartment, supplementary flaps are opened. FIG. 4 shows the situation in which the flaps 11 and 12 are open.

To effect this movement the drive wheel is caused to rotate again. The shaft 211 penetrates into the radial slot 243 and drives the rocker 24 in rotation about its secondary rotation axis. The recess 211 is then situated in line with the radial slot 243 and frees up the space allowing the rocker 24 to change position, as shown in FIG. 4b.

As the rotation of the drive wheel continues, the shaft 211 releases the radial slot 243. The locking disk 22 engages the semicircular cutout 242 and immobilizes the rocker 24 in this new position. The rotation of the rocker 24 drives the links 32, 321 and 323 and opening of the flaps 11 and 12.

It will be noted here that, when the drive wheel 21 has effected an angular travel of 360°, the two rockers have changed position and have driven the complete opening of the flaps.

The closing of the flaps is effected by causing the drive wheel to turn in the opposite direction, and by executing in order the steps shown in FIGS. 4c, 4b and 4a, to close the flaps 11 and 12, and the steps shown in FIGS. 3c, 3b and 3a to close the flap 10.

The change of position of the rockers is effected in accordance with a particular sequence. And the change of position of a rocker is effected when the other rockers are immobilized in their respective positions by the locking disk.

A result of this is that the motor torque generated by the motor 40 to drive the wheel 21 in rotation is limited to only the torque necessary to cause to turn the rocker controlling the movement of the flap or flaps connected to it from the closed position to the open position and vice versa. Once the movement has been effected, there is no longer any requirement to power the motor 40 to retain the flaps in the required position.

Obviously, the embodiment of a maneuvering device according to the invention is not limited to what has been described above.

It is in fact possible, within the limit of the space available around the drive wheel, to increase the number of rockers, and to provide rockers able to occupy more than two positions. This configuration may be of particular interest when the aim is to increase the number of flaps to reduce the power necessary to cause a flap to pass from one position to another, or to reduce the volume necessary for the relative movement of the flaps, but also when the aim is finer modulation of the flow of air entering into the engine compartment.

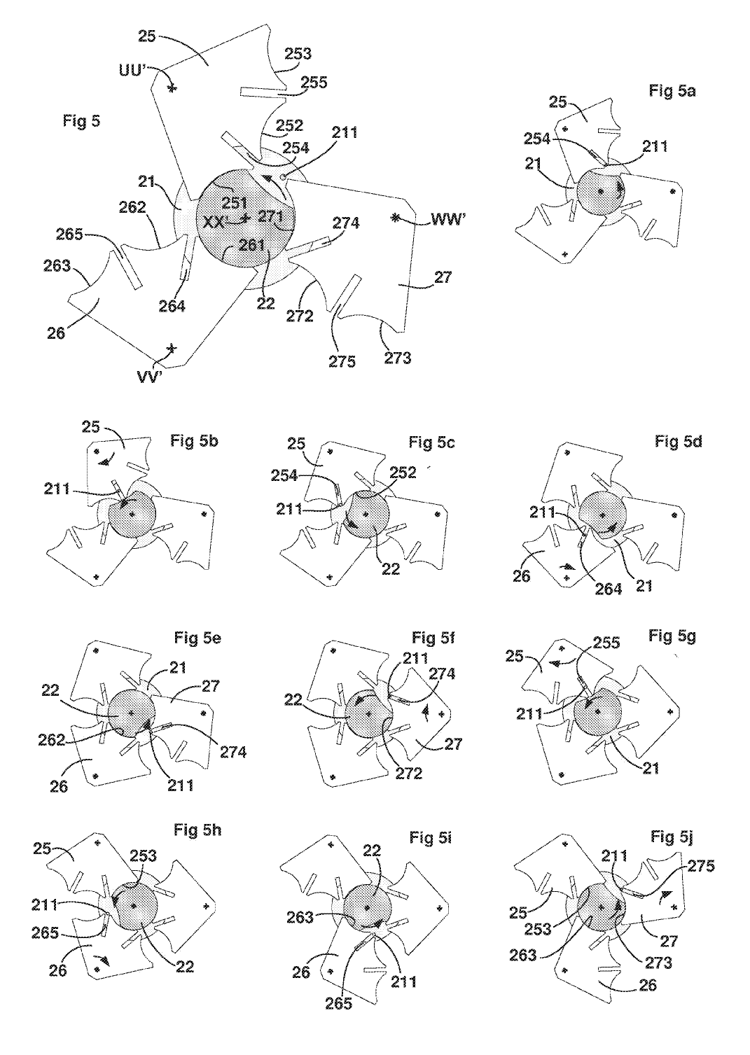

FIG. 5 represents a nonlimiting alternative construction in which the drive wheel 21 is surrounded by three rockers, respectively 25, 26, 27 each articulated about a respective secondary rotation axis UU′, VV′ and WW′ parallel to the main axis XX′. Each rocker comprises three semicircular cutouts respectively 251, 252, 253, 261, 262, 263 and 271, 272, 273, and can therefore occupy three different positions.

A radial slot, respectively 254, 255, 264, 265, 274, 275, is interleaved between the adjacent semicircular cutouts of each pair, which results in two radial slots per rocker.

The rockers 25, 26 and 27 from FIG. 1 are each immobilized in a first position by the locking disk 211.

FIGS. 5a to 5j show the kinematic of the rockers when the drive wheel 21 is caused to rotate:

FIG. 5a: the axial shaft penetrates into the radial slot 254 of the rocker 25.

FIG. 5b: the rocker 25 rotates about its secondary rotation axis.

FIG. 5c: the locking disk engages the semicircular cutout of the rocker 25, and the axial shaft 211 leaves the radial slot 254. The rocker 25 is then immobilized in a second position.

FIG. 5d: the shaft 211 is engaged in the radial slot 264 of the rocker 26 and drives the latter in rotation about its secondary axis.

FIG. 5e: the rocker 26 is retained in a second position by the locking disk, and the axial shaft 211 is engaged in the radial slot 274 of the rocker 27 to drive the latter in rotation about its secondary axis.

FIG. 5f: the locking disk 22 engages in the semicircular cutout 272 of the rocker 27 to immobilize the latter in a second position, and the axial shaft 211 leaves the radial slot. At this stage, the drive wheel 21 has effected a first turn about the main axis.

FIG. 5g: the axial shaft 211 is engaged in the radial slot 255 of the rocker 25 to cause the latter to turn about its secondary axis.

FIG. 5h: the locking disk immobilizes the rocker 25 in a third position. The axial shaft engages in the radial slot 265 of the rocker 26.

FIG. 5i: The locking disk 22 engages in the semicircular cutout 263 of the rocker 26 to lock the latter in a third position.

FIG. 5j: the rocker 27 completes its rotation about its secondary rotation axis and the axial shafts 211 leaves the radial slot 275. The locking disk engages the semicircular cutout 273 and immobilizes the rocker 27 in its third position. At this stage, the drive wheel has effected a second turn.

When the drive wheel has effected these two turns, corresponding to the number of radial slots supported by each of the rockers, each of said rockers has occupied all of the three possible positions corresponding to the three semicircular cutouts formed at their peripheries.

The closure of the flaps is effected by causing the drive wheel to turn in the other direction, and by carrying out the sequence described above in reverse order.

It is again noted that the change of position of a rocker is effected when the other rockers are immobilized in their respective positions, which allows reduction of the motor torque to cause the drive wheel to rotate to the torque necessary to effect the change of position of only one rocker.

The sequence of opening and of closing the flaps is effected in accordance with the order of positioning the rockers around the main axis XX′.

Other variants may equally be envisaged in which, for example, the drive wheel supports two locking disks disposed one on each of the faces of the disk formed by the drive wheel. The rockers are then placed on either side of the drive wheel. This variant allows problems of overall size to be solved or the number of flaps that can be actuated by the mechanical means to be increased.

### TERMS INDEX

10 Pivoting flap
11 Pivoting flap
12 Pivoting flap.
2 Mechanical means
21 Drive wheel
211 Axial shaft
210 Face of the drive wheel supporting the locking disk
22 Locking disk
221 Recess
23, 24, 25, 26, 27 Rockers
231, 232, 241, 242, 251,252, 253, 261, 262, 263, 271, 272, 273, Semicircular cutouts
233, 243, 254, 255, 264, 265, 274, 275 Radial slots
31, 311, 32, 32a, 321, 322 Mechanical transmission means; links
40 Motor
41 Gearbox
aa′ Pivot axis of flap 10
bb′ Pivot axis of flap 11
cc′ Pivot axis of flap 12
r₁ Radius of the drive wheel
r₂ Radius of the locking disk
r₃ Distance of the axial shaft from the main axis XX′.
SS′ Secondary rotation axis of the rocker 23
TT′ Secondary rotation axis of the rocker 24
UU′ Secondary rotation axis of the rocker 25
VV′ Secondary rotation axis of the rocker 26
WW′ Secondary rotation axis of the rocker 27
tt′ Rotation axis of the link 32a on the rocker 24.
XX′ Main axis

1. A device for maneuvering a plurality of flaps, each pivoting about an axis, and intended to be placed in front of a cooling device of a motor vehicle wherein the device comprises: a mechanical device including a drive wheel, driven in rotation about a main axis, one face of the disc formed by the drive wheel supporting in a raised position a circular locking disc with a diameter smaller than and the same rotation axis as the drive wheel, the maneuvering device further including a plurality of rockers, each freely articulated about a secondary axis which are parallel to the main axis and connected by mechanical transmission to one or more flaps, said rockers comprising at least two semicircular cutouts having a radius equal to a radius of the circular locking disc and which are arranged so that, when a rocker is placed in one position, a center of at least one of the at least two semicircular cutout is placed on the main axis, so that the circular locking disc engages with the at least one of the at least two semicircular cutout and locks said rocker in said one position.

2. The maneuvering device as claimed in claim 1, in which the semicircular cutouts are placed on a peripheral edge of the rocker.

3. The maneuvering device as claimed in claim 1, in which the drive wheel supports an axial shaft disposed on the same face of the disk formed by the drive wheel supporting the circular locking disk, at a distance from the main axis greater than a radius of the circular locking disk.

4. The maneuvering device as claimed in claim 3, in which each rocker comprises radial slots disposed between two adjacent semicircular cutouts, in which said shaft circulates to cause a rocker to pivot from one position to another position adjacent a preceding position about its secondary axis.

5. The maneuvering device as claimed in claim 3, in which the circular locking disk includes a recess disposed radially in line with the axial shaft, in such a manner as to allow the pivoting of a rocker when the latter changes position.

6. The maneuvering device as claimed in claim 1, in which the mechanical transmission connecting one of the rockers to one or more flats are formed by:
a set of links connecting a body of the rocker to a rotation shaft or to a rear face of the flap or flaps,
a flexible cable transmission of push/pull type,
a system of gears.

7. The maneuvering device as claimed in claim 1, in which each rocker successively occupies a number of fixed positions equal to a number of semicircular recesses that the rocker supports, so that it is possible to dispose the flaps successively in a plurality of particular fixed positions to adjust a quantity of air reaching the cooling device.

8. The maneuvering device as claimed in claim 1, in which, when the drive wheel effects a rotation of one turn, each of the rockers effects, in accordance with a sequence imposed by the direction of rotation of the drive wheel, a movement of rotation from one position to another position adjacent to a preceding position.

9. The maneuvering device as claimed in claim 14, in which each rocker successively occupies each possible particular fixed positions when the drive wheel has effected as many turns on itself as a number of radial slots supported by a rocker.

10. The maneuvering device as claimed in claim 1, in which, when a rocker is placed in a position, a torque applied to the main rotation shaft, resulting from the aerodynamic forces exerted on the flap or flaps connected to said rocker when the vehicle is in motion, is substantially zero.

11. The maneuvering device as claimed in claim 1, in which the drive wheel is rotated by a motor coupled to a gearbox.

12. The device as claimed in claim 1, in which the rotation of the drive wheel may be interrupted between the change of position of two rockers circumferentially placed in adjacent positions, so that some of the flaps are in a position different from the position of others.

13. The device as claimed in claim 1, disposed in front of the cooling device of a motor vehicle.

14. The maneuvering device as claimed in claim 2, in which the drive wheel supports an axial shaft disposed on the same face of the disk formed by the drive wheel supporting the circular locking disk, at a distance from the main axis greater than a radius of the circular locking disk.

15. The maneuvering device as claimed in claim 4, in which the circular locking disk includes a recess disposed radially in line with the axial shaft, in such a manner as to allow the pivoting of a rocker when the latter changes position.

16. The maneuvering device as claimed in claim 4, in which the circular locking disk includes a recess disposed radially in line with the axial shaft, in such a manner as to allow the pivoting of a rocker when the latter changes position.
